(19) United States
(12) Patent Application Publication
(10) Pub. No.: US 2020/0165843 A1
(43) Pub. Date: May 28, 2020

(54) VEHICULAR LATCH ASSEMBLY WITH SNAP-TYPE CONNECTION FEATURE PROVIDING AN INTEGRATED SEALING FUNCTION

(71) Applicant: Magna Closures Inc., Newmarket (CA)

(72) Inventors: Claudio MICHETTI, Capezzano Pianore (IT); Franco Giovanni OTTINO, San Giuliano Terme (IT)

(21) Appl. No.: 16/695,694

(22) Filed: Nov. 26, 2019

Related U.S. Application Data
(60) Provisional application No. 62/772,164, filed on Nov. 28, 2018.

(51) Int. Cl. E05B 77/34; E05B 85/02

(52) U.S. Cl. CPC E05B 77/34; E05B 85/02

(57) ABSTRACT

A sealed latch assembly for a vehicle closure panel is provided. The latch assembly includes a housing having an internal cavity sized for receipt of internal components of the latch assembly. A cover is attached to the housing to enclose at least a portion of the internal cavity. The latch assembly includes a sealing member and a deflector member that are brought into engagement to define a sealing interface. The sealing member contacts a side of the deflector member when assembled, and the sealing member is deflected to create a water-tight seal. The housing and the cover are secured by a snap fit arrangement with a low compressive load, as the deflector does not compress the seal member.

### CROSS-REFERENCES TO RELATED APPLICATIONS

This patent application claims priority to U.S. Provisional Patent Application Ser. No. 62/772,164 filed Nov. 28, 2018 which is incorporated herein by reference in its entirety.

### FIELD

The present disclosure relates generally to latch assemblies of vehicle closure panels, and more particularly to latch assemblies having a sealing feature enabling a connection feature having a reduced compressive load between a latch housing and cover.

### BACKGROUND

This section provides background information related to the present disclosure that is not necessarily prior art.

Vehicle doors are typically equipped with a latch assembly configured to allow selective opening and closing of the door. Latch assemblies commonly have multiple components assembled to one another, such as a housing and cover having peripheries brought into mating abutment with one another, as well as a multiple functional internal components contained within the housing/cover assembly. Further, openings are typically formed in the housing and/or cover to allow for the through passage of one or more members, such as electrical wires or Bowden cables for example, for operable connection to one or more of the functional internal components.

Problems can arise if water is permitted to enter the latch assembly. For example, the ingress of water can cause corrosion, and if allowed to freeze, can damage and/or jam internal components, thereby preventing internal components from functioning as intended. Unfortunately, seams and/or gaps, through which water can penetrate, are established where the housing and cover interface with one another, as well as between openings and wires/cables passing therethrough, and thus, potential damage and jamming may occur as a result thereof.

The aforementioned problem has led to housing and cover connections that include a sealing bead along at least a portion of the housing and cover to prevent ingress of water into the interior of the latch assembly at the location of the sealing bead. Prior solutions typically require that the cover and housing be compressed together on the sealing bead to fill in any gaps as the sealing bead is compressed. The compression of the sealing bead results in a decompressive reaction force, which tends to push the cover and housing away from each other.

Accordingly, fasteners capable of applying a substantial compressive load and being resistance to the decompressive reaction force are typically used at a number of fastening locations. The fasteners must be substantially tightened to ensure that the sealing bead remains compressed and that the cover and housing do not separate over time. The high amount of compressive load can often lead to damage to the cover and/or housing during assembly.

In some cases, the damage to the cover and/or housing may not be initially detectable, which can lead to failures after installation of the latch assembly, thereby requiring costly repair and/or replacement of the latch.

### SUMMARY

This section provides a general summary of the disclosure and is not intended to be considered a complete and comprehensive listing of the disclosure's full scope or all of its aspects, advantages, objectives and/or features.

It is an object of the present disclosure to provide a sealed latch assembly that inhibits the ingress of water into an internal cavity containing latch components, thereby preventing jamming due to freezing and inhibiting the onset of corrosion.

It is a further object of the present disclosure to provide a latch assembly having one or more seal members to inhibit the ingress of water between an interface of a housing and cover of the latch assembly.

It is a further object of the present disclosure to provide a sealed latch assembly that is economical in manufacture, shipping and assembly.

It is a further object of the present disclosure to provide a sealed latch assembly that exhibits a long and useful life.

In accordance with these objectives, as well as others, which will be appreciated by those possessing ordinary skill in the art, the present disclosure is directed to providing a sealed latch assembly for a vehicle closure panel.

In one aspect, a latch assembly for a vehicle closure panel includes a housing having an internal cavity configured for receipt of internal latch components and a cover attached to said housing to enclose at least a portion of said internal cavity. At least one seal member is configured to form a water-tight seal between said housing and said cover, and at least one deflector is in contact with the at least one seal member at a sealing interface to define the water-tight seal between the at least seal member and the deflector, wherein the deflector includes a top portion and a side portion.

The at least one seal member is disposed on one of either the housing or the cover, and the deflector is disposed on the other of the housing or the cover. The at least one seal member is deflected by the side portion of the deflector relative to a nominal position of the seal member, wherein the sealing interface is disposed on the side portion of the deflector.

In one aspect, the at least one seal member is a single flexible lip member.

In one aspect, the at least one seal member includes a pair of flexible lip members.

In one aspect, the pair of flexible lip members are laterally offset from a center of the deflector.

In one aspect, the single flexible lip member is laterally offset from a center of the deflector.

In one aspect, the nominal position of the seal member interferes with the deflector.

In one aspect, the housing and the connector combine to define a passageway in which the at least one seal member and the deflector are disposed.

In one aspect, the passageway has a height, and the at least one seal member has a height that is less than the height of the passageway.

In one aspect, the passageway has a height and the at least one seal member has a nominal height that is greater than the height of the passageway, wherein the at least one seal member is bent relative to its nominal position within the passageway and contacts a surface of the passageway.

In one aspect, the housing and the cover are secured to each other by a snap fit connection.

In one aspect, the housing and the cover are secured to each other without the use of screw-type fasteners.

In one aspect, the deflector has a tapered cross-section.

In one aspect, the at least one seal member includes a pair of flexible lip members, and the pair of flexible lip members are deflected away from each other and contact opposite lateral sides of the deflector.

In accordance with a further aspect of the disclosure, a latch assembly for a vehicle closure panel includes a housing having an internal cavity configured for receipt of internal latch components and a cover configured to attach to the housing to enclose at least a portion of the internal cavity. The assembly further includes at least one seal member configured to form a water-tight seal between said housing and said cover and at least one deflector configured to contact the at least one seal member at a sealing interface to define the water-tight seal between the at least seal member and the deflector.

The assembly has a disassembled state and an assembled state. In the disassembled state, the at least one seal member has a nominal state and is disposed above the deflector and aligned with a side of the deflector. In the assembled state, the at least one seal member is in contact with the side of the deflector and deflected relative to the nominal state and defines the sealing interface.

In one aspect, the housing is secured to the cover in the assembled state via a snap fit connection.

In one aspect, the sealing member is not compressed between the housing and the cover.

In one aspect, the housing is secured to the cover without screw-type fasteners.

In one aspect, the deflector includes an uppermost tip that does not contact the sealing member in the assembled state.

In one aspect, the sealing member includes a single flexible lip that is offset from a center of the deflector in both the disassembled and the assembled conditions.

In one aspect, the sealing member includes a pair of flexible lips, each of which are offset from a center of the deflector in both the disassembled and the assembled conditions.

In another aspect, a method of assembling a latch assembly for a vehicle closure panel is provided. The latch assembly includes a housing having an internal cavity configured for receipt of internal latch components, a cover configured to attach to the housing to enclose at least a portion of the internal cavity, at least one seal member configured to form a water-tight seal between said housing and said cover, and at least one deflector configured to contact the at least one seal member at a sealing interface to define the water-tight seal between the at least seal member and the deflector. The method includes: bringing the cover and the housing into engagement; deflecting the at least one seal member using the deflector away from the deflector during the step of bringing the cover and the housing into engagement; and maintaining the at least one seal member in contact with the deflector at a sealing interface to define the water-tight seal between the seal member and the deflector.

In one aspect, the deflecting the at least one seal member includes laterally moving the at least one seal member away from the deflector.

In one aspect, the deflecting the at least one seal member does not compress the at least one seal member.

In one aspect, the method includes snap-fitting the cover and the housing into engagement.

In accordance with another aspect, there is provided a housing assembly, including a housing having a first portion and a second portion defining an internal cavity when assembled, at least one seal member configured to form a water-tight seal between the first portion and the second portion; at least one deflector in contact with the at least one seal member at a sealing interface to define the water-tight seal between the at least one seal member and the deflector, the at least one seal member is disposed on one of either the first portion or the second portion, and the deflector is disposed on the other of the first portion or the second portion, the at least one seal member is deflected by the deflector relative to a nominal position of the seal member when the first portion and the second portion are assembly.

In accordance with another aspect, there is provided a sensor housing assembly, including a housing having a first portion and a second portion defining an internal cavity for housing sensor electronics when in an assembled condition, at least one seal member configured to form a water-tight seal between the first portion and the second portion; at least one deflector in contact with the at least one seal member at a sealing interface to define the water-tight seal between the at least one seal member and the deflector, the at least one seal member is disposed on one of either the first portion or the second portion, and the deflector is disposed on the other of the first portion or the second portion, the at least one seal member is deflected by the deflector relative to a nominal position of the seal member when the first portion and the second portion are assembly.

In accordance with a related aspect the first portion and the second portion are in the assembled condition together without the using of metallic fasteners. In accordance with a related aspect the sensor electronics includes at least one of a printed circuit board and sensor antennas. In accordance with a related aspect the sensor electronics are configured to at least one of transmit and receive radar signals.

Further areas of applicability will become apparent from the detailed description provided herein. The description and specific examples provided in this summary are intended for purposes of illustration only and are not intended to limit the scope of the present disclosure.

### BRIEF DESCRIPTION OF THE DRAWINGS

Other aspects and advantages of the present non-limiting embodiments will be readily appreciated, as the same becomes better understood by reference to the following detailed description and appended claims when considered in connection with the accompanying drawings, wherein:

FIG. 1 is a partial perspective view of a motor vehicle equipped with a pivotal passenger-entry door having a door handle operably interconnected to a latch assembly constructed in accordance with and embodying the teachings of the present disclosure;

FIG. 2 is a plan view of the latch shown in FIG. 1 with a portion of a housing of the latch omitted and showing a secondary pawl locking position;

FIG. 3 is a plan view of the latch shown in FIG. 2 in a secondary pawl release position;

FIG. 4 is a perspective view of the latch assembly of FIG. 1;

FIG. 5 is another perspective view of the latch assembly of FIG. 1 looking generally along the direction of arrow 5 of FIG. 4;

FIG. 6 is an interior plan view of the cover of the latch assembly of FIG. 1;

FIG. 7 is an interior plan view of the housing of the latch assembly of FIG. 1;

FIG. 8 is a partial cross-sectional view of the cover and the housing in an assembled arrangement;

FIG. 9 is an enlarged cross-sectional view of a sealing interface between the cover and the housing and a snap fit connection between the housing and the cover;

FIG. 10 is a schematic view illustrating one aspect of a sealing member on the cover being brought into engagement with a deflector on the housing;

FIG. 11 is a schematic view illustrating another aspect of a sealing member on the cove being brought into engagement with a deflector on the housing;

FIG. 12 is a flowchart of a method of assembling a latch, in accordance with an illustrative embodiment;

FIG. 13 is a side cross-sectional view of the latch of FIG. 9, illustrating a housing and a cover connected together using a snap-fit connection;

FIG. 14 is a side view of the latch of FIG. 9, illustrating the housing and the cover connected together with an evenly distributed seal load between connectors; and

FIG. 15 is a side view of a prior art latch assembly illustrating the cover and the housing in an assembled arrangement with an unevenly distributed seal load between connectors.

Corresponding reference numerals indicate corresponding components throughout the several views of the drawings, unless otherwise indicated.

### DETAILED DESCRIPTION OF THE EXAMPLE EMBODIMENTS

In general, example embodiments of lockable release cable assemblies of the type configured for use with motor vehicle closure systems, constructed in accordance with the teachings of the present disclosure, will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

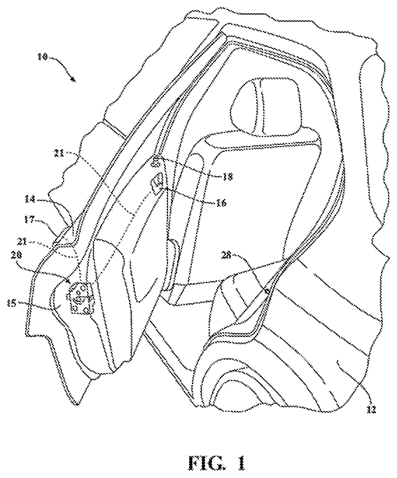

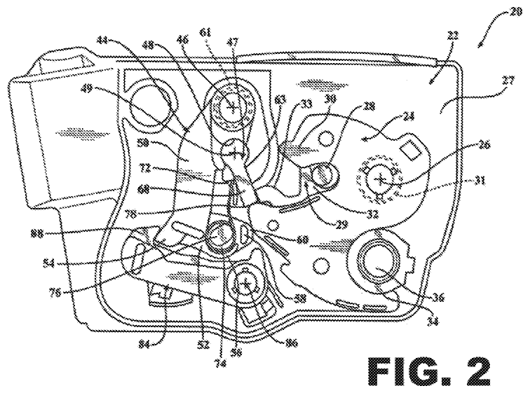

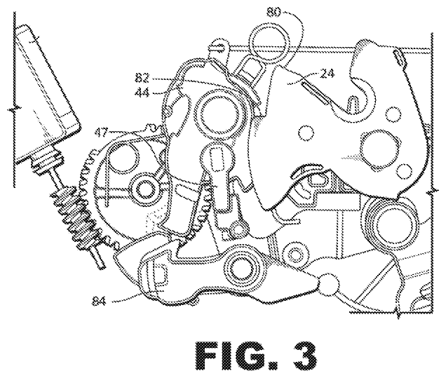

FIG. 1 is a perspective view of a vehicle 10 that includes a vehicle body 12 and at least one vehicle closure panel, shown as a vehicle door 14, by way of example and without limitation. The vehicle door 14 includes an edge face 15, inside and outside door handles 16, 17, a lock knob 18, with at least one hinge pivotally fixing the door 14 to the vehicle body 12. A latch assembly 20 is positioned or sealing affixed against an inner surface of the edge face 15. The latch assembly 20 includes a latch mechanism having a pivotal latch (i.e. ratchet) member 24 (FIGS. 2 and 3) that is releasably engageable with a striker 28 mounted on the vehicle body 12 to releasably hold the vehicle door 14 in a closed position. The lock knob 18 (optional) is shown and provides a visual indication of the lock state of the latch assembly 20 and may be operable to change the lock state between an unlocked state and a locked state. At least one of the handles 16, 17 is operably connected to the latch assembly 20 via a wire or release cable 21, such as a Bowden cable, by way of example and without limitation, for facilitating actuation of latch assembly 20 via intended (selective) operation of the handles 16, 17. For example, release cable 21 may be another type of cable, such as a cinch cable, or a lock or unlock cable, or the like. Specifically, the release cable 21 operably connects one of handles 16, 17 to the functionally moveable latch member release component 24 of the latch assembly 20 for opening or unlatching the latch assembly 20 (i.e. for releasing striker 28 from latched engagement with the latch member 24) to open the vehicle door 14. As is detailed hereafter, the latch assembly 20 is constructed and otherwise configured to inhibit the ingress of water therein, thereby eliminating the potential for jamming of functional internal components due to freezing and further inhibiting the onset of corrosion of functional internal components. To facilitate the inhibition of water ingress, the latch assembly 20 may include a water shield 19 and at least one or more seal members to inhibit the ingress of water between an interface of a housing 22 and cover 23 of the latch assembly 20 and to inhibit the ingress of water into a cavity 27 containing internal latch components between openings in the housing 22 and/or cover 23. Accordingly, the latch assembly 20 is able to function as intended, for an extended useful life, without concern of malfunction resulting from phenomenon related to the ingress of water.

In general, the closure panel 14 (e.g. occupant ingress or egress controlling panels such as, but not limited to, vehicle doors and lift gates/hatches) is connected to vehicle body 12 via one or more hinges (e.g. for retaining closure panel 14). Closure panel 14 can be referred to as a partition or door, typically hinged, but sometimes attached by other mechanisms such as tracks, in front of an opening which is used for entering and exiting vehicle 10 interior by people and/or cargo. It is also recognized that closure panel 14 can be used as an access panel for vehicle systems such as engine compartments and traditional trunk compartments of automotive type vehicles 10. It is to be recognized that the hinge(s) can be configured as a biased hinge that is operable to bias closure panel 14 toward the open position and/or toward the closed position, as desired. The vehicle body 12 can include the mating latch component 28 (e.g. striker) mounted thereon for coupling with a respective functional latching component 24 (i.e. the ratchet) of latch assembly 20 mounted on closure panel 14. Alternatively, latch assembly 20 can be mounted on vehicle body 12 and the mating latch component 28 can be mounted on the closure panel 14 (not shown, but will be readily understood by one skilled in the art).

Movement of the closure panel 14 (e.g. between the open and closed positions) can be electronically and/or manually operated, where power assisted closure panels 14 can be found on minivans, high-end cars, or sport utility vehicles (SUVs) and the like. As such, it is recognized that movement of the closure panel 14 can be manual or power assisted during intended operation of closure panel 14, for example, between fully closed (e.g. locked or latched) and fully open positions (e.g. unlocked or unlatched); between locked/latched and partially open positions (e.g. unlocked or unlatched); and/or between partially open (e.g. unlocked or unlatched) and fully open positions (e.g. unlocked or unlatched). It is recognized that the partially open position of the closure panel 14 can also include a secondary lock position.

In terms of vehicles 10, closure panel 14 may be a driver/passenger door, a lift gate, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or toward) the opening in body 12 of vehicle 10. Also contemplated are sliding door embodiments of closure panel 14 and canopy door embodiments of closure panel 14, such that sliding doors can be a type of door that open by sliding horizontally or vertically, whereby the door is either mounted on, or suspended from a track that provides for a larger opening. Canopy doors are a type of door that sit on top of the vehicle and lift up in some way, to provide access for vehicle passengers via the opening (e.g. car canopy, aircraft canopy, etc.). Canopy doors can be connected (e.g. hinged at a defined pivot axis and/or connected for travel along a track) to the body 12 of the vehicle 10 at the front, side or back of the door, as the application permits. It is recognized that body 12 can be represented as a body panel of vehicle 10, a frame of vehicle 10, and/or a combination frame and body panel assembly, as desired.

With regard to the latch assembly 20, FIG. 2 is a plan view showing some of the functional internal latch components of one possible embodiment of latch assembly 20 in accordance with the disclosure, while those possessing ordinary skill in the art of vehicle latches will readily appreciated other latch arrangements. The latch assembly 20 includes the housing 22 bounding, at least in part, the internal cavity 27 in which the primary ratchet 24 (which may, for convenience, be referred to simply as the ratchet 24) is pivotally mounted via a primary ratchet pin joint for rotation about a primary ratchet pivot axis 26 mounted in the housing 22. The ratchet 24 pivots between a fully closed position (FIG. 2) wherein the striker 28 is captured in a slot 29 by a hook 30 of the ratchet 24, and an open position (FIG. 3) wherein the striker 28 is not trapped by the hook 30 and is free to move out of the slot 29 presented by the ratchet 24. In the view shown in FIG. 2 the ratchet 24 rotates clockwise to move from the closed position to the open position.

The ratchet 24 is biased towards the open position via a ratchet biasing member 31. The biasing member 31 may be any suitable type of biasing member, such as, for example, a torsion spring. A striker bumper 32 is mounted in the housing 22 (underneath the ratchet 24) to cushion against the striker force of impact and a ratchet bumper 34 is also mounted about a post 36 provided in the housing 22 to cushion against the ratchet force of impact.

An auxiliary ratchet 44 is also pivotally mounted in the internal cavity 27 of housing 22 via an auxiliary ratchet pin joint 46 for movement about an auxiliary ratchet pivot axis 46. A primary pawl 47 is pivotally mounted to the auxiliary ratchet 44 via a primary pawl pin joint 49 for movement about a primary pawl pivot axis. The auxiliary ratchet 44 is movable between a primary pawl enabling position (FIG. 2) and a primary pawl disabling position (FIG. 3). In the primary pawl enabling position, the auxiliary ratchet 44 permits the primary pawl 47 to move to a ratchet locking position to hold the ratchet 24 in the closed position, as shown in FIG. 2. In the primary pawl disabling position (FIG. 3) the auxiliary ratchet 44 prevents movement of the primary pawl 47 to the ratchet locking position, and instead holds the primary pawl 47 in a ratchet release position, as discussed in greater detail below. In the view shown in FIG. 2, the auxiliary ratchet 44 rotates clockwise to reach the primary pawl disabling position.

The auxiliary ratchet 44 includes a cylindrical bore 48, which receives a cylindrical stub of the primary pawl 47 for pivotally mounting the primary pawl 47 into the bore 48, thereby forming pin joint 49 of the auxiliary ratchet 44. This provides a simple means for mounting the primary pawl 47, which may be formed from a simple stamped or sintered metal piece.

The auxiliary ratchet 44 also includes a leg 50 that optionally, as shown in FIG. 2, terminates in an anvil 52 having a check shoulder 54 and a cam lip 56. The auxiliary ratchet 44 may be encapsulated with an elastomeric material and features an optional hollow 58 (FIG. 2) so as to provide an elastically deformable band 60 for contacting and absorbing impact against the ratchet 24.

An auxiliary ratchet biasing member 61 located on the opposing side of the housing 22 biases the auxiliary ratchet 44 to the primary pawl disabling position. Only the hub portion of the auxiliary ratchet biasing member 61 is shown in FIG. 2, (and is shown in stippled lines), for simplicity. The biasing member 61 may include a first tang (not shown) that abuts a capstan of pin joint 46 and a second tang which cooperates with a fork (not shown) in the auxiliary ratchet 44 via a slot (not shown) formed in the housing 22.

Referring back to FIG. 2, the primary pawl 47 includes a check arm 68. In the ratchet locking position the check arm 68 stops the ratchet 24 from opening by abutting contact with a surface of the ratchet 24. The primary pawl 47 rotates clockwise to move to the ratchet release position.

The angular sweep of the check arm 68 is limited on one side by an edge 63 in the auxiliary ratchet 44 and on the other side by the auxiliary ratchet leg 50. A proboscis bumper 72 formed from an encapsulation of the primary pawl 47 may be provided to cushion impact of check arm 68 against the auxiliary ratchet leg 50. An extension 33 of the striker bumper 32 may be provided to reduce or cushion impact of check arm 68 against the auxiliary ratchet edge 63.

The primary pawl 47 is biased towards the ratchet locking position by a primary pawl biasing member 74 wrapped around a post 76 provided in the anvil 52 of the auxiliary ratchet 44. One tang (not visible in FIG. 2) of the biasing member 74 rides against the auxiliary ratchet leg 50, and another tang 78 abuts the check arm 68 of the primary pawl 47. As the biasing member 74 is mounted to the auxiliary ratchet 44 rather than the fixed housing 22, the biasing forces on the primary pawl 47 will not vary appreciably as the auxiliary ratchet 44 rotates. In embodiments wherein the post 76 is not provided, the biasing member 74 may be provided on the housing 22 or at some other location on the auxiliary ratchet 44.

As shown in FIG. 3, ratchet 24 features primary and secondary locking surfaces 80 and 82 that interact with the check arm 68 (FIG. 2) of the primary pawl 47. The primary locking surface 80 provides a fully closed position for the ratchet 24 in which the striker 28 is securely ensconced in the slot 29 of the ratchet 24 such that the vehicle door 14 is completely closed and the door seals are compressed. The secondary locking surface 82 provides a partially closed and locked position of the ratchet 24 wherein the striker 28 is loosely secured in the slot 29 of the ratchet 24 such that the vehicle door 14 is locked but not completely closed against the door seals.

A secondary pawl 84 is pivotally mounted in the housing 22 via a secondary pawl pin joint for movement about a secondary pawl pivot axis 86 for movement between an auxiliary ratchet holding position where the secondary pawl 84 holds the auxiliary ratchet 44 in the primary pawl enabling position, as shown in FIG. 2, and an auxiliary ratchet release position in which the secondary pawl 84 permits the auxiliary ratchet 44 to move to the primary pawl disabling position, as shown in FIG. 3. In the view shown in FIG. 2 the secondary pawl 84 rotates counterclockwise to reach the auxiliary ratchet release position. The secondary pawl 84 includes a hook shoulder 88 for engaging the auxiliary ratchet check shoulder 54. The secondary pawl 84 is biased towards the auxiliary ratchet holding position by a secondary pawl biasing member. The secondary pawl biasing member may be any suitable type of biasing member, such as, for example, a torsion spring.

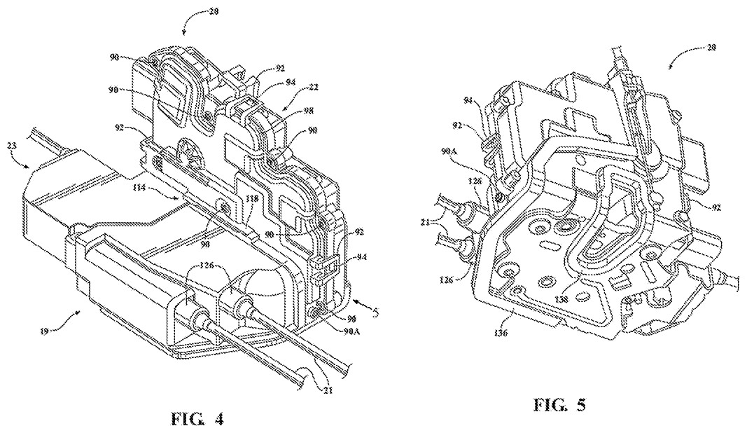

Referring to FIGS. 4 and 5, the water shield 19, housing 22 and cover 23 of the latch assembly 20 are shown assembled together to establish a water-tight sealed attachment with one another. Illustratively, the housing 22, and example of a first portion of a housing assembly, and cover 23, and example of a second portion of a housing assembly, of the latch assembly 20 may be manufactured of a plastic material formed by a plastic injection molding process, by way of example and without limitation, but may also be formed from, or in combination with, for example, a metal material, a carbon fiber material, or other like materials. Further, the release cables 21 are shown in coupled relationship to the water shield 19 of latch assembly 20 to establish a water-tight sealed attachment therewith. Accordingly, water is inhibited from entering the latch assembly 20, thereby ensuring the internal components function as intended and resist corrosion, regardless of external environmental conditions/temperature.

The housing 22 and cover 23 are shown attached to one another to enclose at least a portion or the entirety of cavity 27 via a fastening mechanism, and are shown, by way of example and without limitation, as being securely attached to one another via a plurality of threaded fasteners 90 and coupled snap or hook members, shown as fingers 92 of the cover 23 being hooked about tabs 94 of the housing 22. It will be appreciated by those possessing ordinary skill in the art that any suitable fastening mechanism can be used, and that one or more of the aforementioned fastening mechanism can be used alone or in combination with one another. Accordingly, one will appreciate that the threaded fasteners 90, fingers 92 and tabs 94 could be used alone, eliminated or provided in reverse relation.

As further described below, the connection feature for securing the housing 22 to the cover 23 may be accomplished with a reduced compressive load on the fasteners 90. In one approach, the fasteners 90 may be omitted from the assembly of the housing 22 and the cover 23, and a snap-fit type connection 91 using the fingers 92 and tabs 94 may be used in the place of some or all of the illustrated fastener locations. This reduced compressive load and potential elimination of the screw-type fasteners is possible due to the substantially non-compressive seal arrangement, further described below.

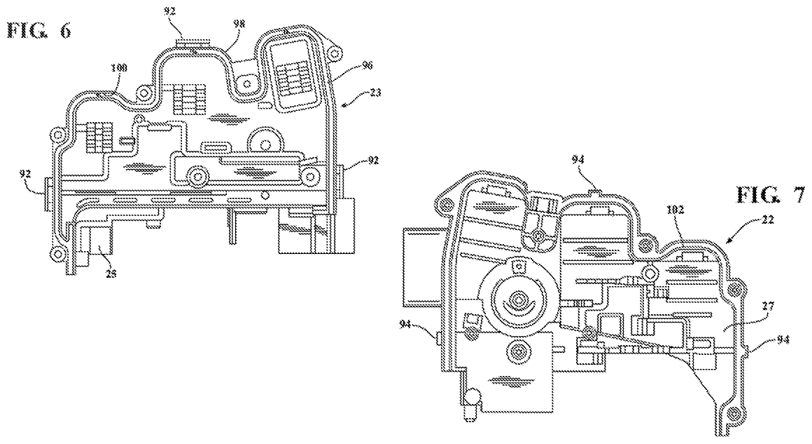

Water is prevented or at least greatly inhibited from entering the internal cavity 27 between an interface defined between the housing 22 and the cover 23 via at least one seal member 96, illustrated in FIGS. 6-11. The seal member 96 may be a single member that extends along substantially the entire length of the interface where water is to be blocked. Alternatively, the seal member 96 may be formed from a plurality of individual members that are effectively aligned end to end to cover substantially the entire length of the interface. The plurality of seal members 96 may overlap slightly along their length, if desired.

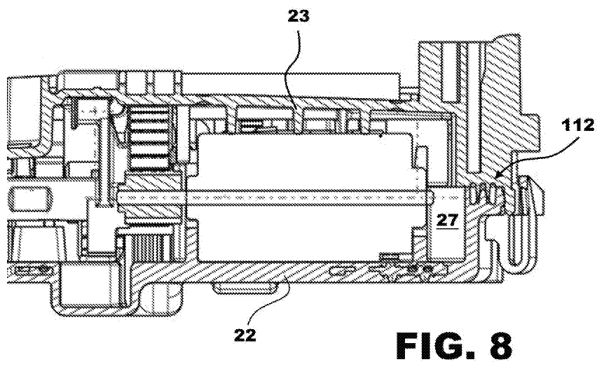

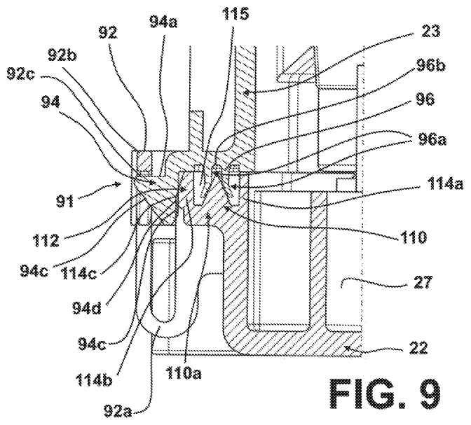

The seal member 96 preferably extends immediately adjacent and about, at least in part, an outer periphery 98 of the cover 23 or housing 22, as shown in FIG. 6. The seal member 96 may be disposed on either the cover 23 or the housing 22. FIG. 6 illustrates the seal member 96 being disposed on the cover 23. The seal member 96 is shown disposed on the housing 22 in other illustrations, as shown in FIGS. 8-9. The seal member 96 is configured to be deflected rather than compressed when the housing 22 and cover 23 are brought together.

With reference to FIGS. 8-11, in one aspect the seal member 96 may include at least one lip member 96a that projects from a surface 96b of the housing 22 or cover 23 disposed adjacent the outer periphery 98. In FIG. 9, the lip members 96a project downward in the figure from the cover 23, but it will be appreciated that the lip members 96a could alternatively project upward in the figure from the housing 22. The lip member 96a is flexible and resilient, and is configured to flex, bend, and/or shift in response to contacting a corresponding structure on the other of the housing 22 or cover 23. The lip member 96a may have a generally tapered shape, with a wider base disposed at the interface with the cover 23 or housing 22 from which is projects, and narrowing in a direction away from the wider base. In another aspect, the lip member 96a may have a generally constant thickness without a substantial taper. An outer tip of the lip member 96a may be rounded or curved or have a convex profile in some aspects.

The seal member 96 is configured to come into contact with a deflector 110 that projects from a surface 110a defined on the housing 22 or cover 23, whichever does not include the seal member 96. Deflector 110 is shown to project outwardly away from surface 110a but other configuration are possible such as deflector 110 may be alternatively configured to project inwardly from the surface 110a to define a cutout in the housing 22 or cover 23 into which seal member 96 may be received or partially received therein. In FIG. 9, the deflector projects upward from the housing 22. When the housing 22 and cover 23 are assembled or brought together, the seal member 96 and deflector 110 are opposed to each other and will come into contact with each other as the housing 22 and cover 23 are moved toward each other. The deflector 110 may include top portion 111a and side portions 111b. As described further herein, the seal member 96 is arranged to be offset from the apex of the top portion 111a such that the seal member 96 will contact one or both of the side portions 111b when the housing 22 and cover 23 are assembled.

As described above, the seal member 96 and the deflector 110 may be disposed on either of the housing 22 and cover 23. For purposes of further discussion, the seal member 96 will be described with reference to FIGS. 8-11, in which the seal member 96 is shown disposed on the cover 23, with the deflector 110 disposed on the housing. Of course, as previously described, this arrangement could be reversed.

The housing 22 and cover 23, when assembled, may combine to define a sealing section or sealing interface 112, which is the section of the assembly where the seal member 96 and the deflector 110 contact each other to block the water from entering the cavity 27. The sealing section 112 may including a sealing passageway 115 that defines a space in which the seal member 96 and the deflector 110 are disposed. The space within the passageway 115 is large enough to allow the sealing member 96 to bend or shift in response to contacting the deflector 110.

The passageway 115 may be defined by an inner wall 114a that extends upward from the surface 110a on the housing 22 and an outer wall 114b that likewise extends upward from the surface 110a on the housing 22. The inner wall 114a and the outer wall 114b may extend to and contact the surface 96b on the cover 23. The passageway 115 may extend around the periphery 98 at a length corresponding to the length of the periphery 98 were water is to be blocked.

In an alternative aspect, the passageway 115 may be defined without the inner wall 114a, such that the passageway 115 may be open to the cavity 27. In this approach, the cavity 27 may still be sealed by the engagement between the seal member 96 and the deflector 110. However, the inclusion of the inner wall 114a may provide additional blocking capabilities.

The seal member 96 and the deflector 110 have nominal positions when the cover 23 and housing 22 are dis-assembled. From these nominal positions, the seal member 96 and the deflector 110 will interfere with each other when assembled. Accordingly, when the housing 22 and cover 23 are assembled, the interference will cause the flexible seal member 96 to give way to the deflector 110. When assembled, the deflector 110 will apply a reaction force against the seal member 96 that will move the seal member 96 away from its nominal position. The deflector 110 may be generally rigid relative to the seal member 96. Accordingly, the seal member 96 will be the component that deflects when brought into interfering engagement with the deflector 110.

The deflector 110 is preferably formed from a substantially rigid material, and may be formed of a hard plastic material that is integral with a plastic material of the housing 22. The seal member 96 may be made from rubber or a similar elastomeric material that is less rigid than the deflector 110, such that it is the seal member 96 that moves in response to the interference. The seal member 96 may be formed as part of a multi-shot injection molding process along with the cover 23, or it may be applied to the cover 23 after the cover 23 is molded through the use of an adhesive or other bonding method. In one aspect, the deflector 110 may similar be formed from a multi-shot injection molding process and be a different material than the housing 22 or cover 23, or it may be applied to the housing 22 or cover 23. In one aspect, the deflector 110 may be the same material as the seal member 96, but the seal member 96 may remain more flexible than the generally rigid deflector due to differing sizes and/or thicknesses affecting relative rigidity.

In one aspect, the deflector 110 may have a generally triangular cross-section, such that it has a tapered shape with a wider base at the surface 110a and a narrower tip. The deflector 110 may also have a rounded or bulbous cross-section, in which the base portion may be wider.

In the nominal position of the seal member 96 and the deflector 110, the seal member 96 is preferably offset from the center of the deflector 110 when the housing 22 and cover 23 are aligned for assembly. Accordingly, when the seal member 96 contacts the deflector 110 during assembly, this offset arrangement and tapered or rounded profile of the deflector 110 will cause the seal member 96 to be pushed to the side of the deflector 110.

The interference and the offset between the seal member 96 and the deflector 110 in their nominal states need not be substantial. A slight interference and offset may be sufficient to control that the seal member 96 will be pushed to the side by the deflector 110 during assembly, and the resilient nature of the seal member 96 will cause the seal member 96 to push back against the side of the deflector 110 to seal the interface between the seal member 96 and the deflector 110.

When the seal member 96 and the deflector 110 are in contact with each other and providing a sealed interface, the forces on the seal member 96 and the deflector 110 are predominantly in the lateral or sideways direction relative to their projection from the cover 23 and housing 22. The interface between the seal member 96 and the deflector 110 is therefore substantially non-compressive in the vertical direction. The non-compressive interface is defined by the tapered shape of the deflector 110 and the offset of the seal member 96 relative to the deflector 110. Accordingly, a vertical compression of the seal member 96 is not necessary or present, thereby reducing the need for a compressive force.

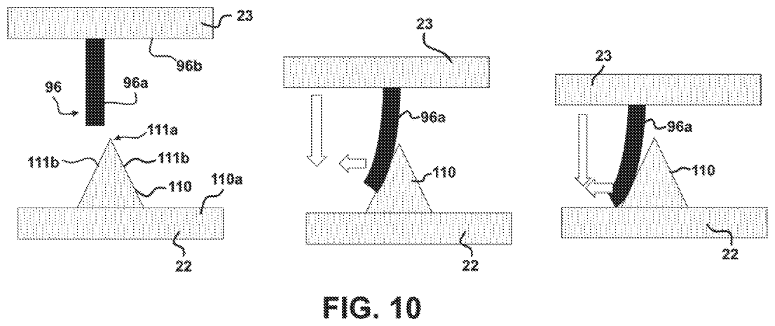

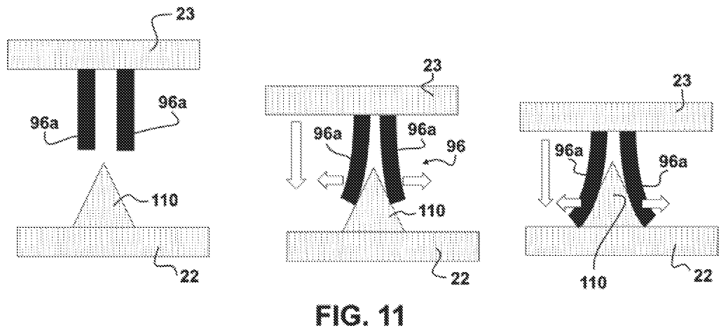

The seal member 96 may have a height that is greater than the height of the passageway 115 or less than the height of the passageway 115. FIG. 9 illustrates the seal member 96 having a height that is less than the passageway 115. FIGS. 10 and 11 illustrate a height that is slightly greater than the height of the passageway. When the height of the seal member 96 is greater than the passageway 115, the seal member 96 may continue to flex and slide along the surface 110a from which the deflector 110 extends. Preferably, when the height of the seal member 96 is greater than the passageway 115, the ultimate vertical measurement of the seal member 96 after being deflected is the same or less than the height of the passageway 115, due to the seal member 96 being bent during deflection. Even when the seal member 96 height is greater than the height of the passageway 115, the deflection of the seal member 115 will cause the seal member 96 to slide laterally across the base of the passageway 115. It will be appreciated that in some cases there will be some vertical compression in this aspect, but the compressive forces present in the seal member 96 are generally unrelated to the sealing ability. Rather, the lateral forces between the seal member 96 and the deflector provide the sealing.

While the seal member 96 has been described in the singular form, the seal member 96 may also be in the form of a pair of the lip members 96a, which is further described below. The above description of the seal member 96 may also apply to the lip members 96a. With regard to the single lip member 96a, which is illustrated in FIG. 10, the lip member 96a may be disposed either inboard or outboard from the deflector 110. Preferably, as shown in FIG. 10, the lip member 96a is disposed outboard from the deflector 110 and flexing outwardly away as it contacts the deflector 110. When the lip member 96a is disposed inboard of the deflector 110, the lip member 96a will flex inwardly from the deflector 110 when contacting the deflector 110.

A pair of the lip members 96a are shown in FIGS. 8, 9, and 11. In this approach, each of the lip members 96a are offset from the center of the deflector 110. When the lip members 96a are moved into contact with the deflector 110, the lip members 96a will contact opposite lateral sides 111b of the deflector 110, and the tips of lip members 96a will move away from each as they bend and flex in response to contact with the deflector 110, as illustrated in the views of FIG. 11.

The lateral contact between the seal member 96, whether using one of the lip members 96a or two of the lip members 96a, provides the sealing interface between the housing 22 and the cover 23 without requiring a large compressive force between the housing 22 and the cover 23. The large compressive force is not necessary because the seal member 96 does not need to be compressed to define the sealing interface. Accordingly, the housing 22 and the cover 23 may be joined together with a smaller required force. Put another way, the uppermost portion or tip of the deflector 110 does not contact the seal member 96, unlike how a compressive seal member and bead interface provides a seal by pressing the top of the bead into the seal material.

In one aspect, the housing 22 and the cover 23 may be attached to each other through the use of a snap fit arrangement or connection 91, and without the need for separate screw-type fasteners to provide a substantial compressive force because a highly compressive is not needed to define a water-tight sealing interface. The snap fit arrangement may be provided by a tab-and-finger connection 91. The fingers 92 and tabs 94 were previously described as part of an attachment arrangement that also included the fasteners 90.

The fingers 92 and tabs 94 are shown in FIGS. 6 and 7 along with the fasteners 90, with the fingers 92 being disposed on the cover 23 and the tabs 94 being disposed on the housing 22. However, the opposite arrangement may also be used, as shown in FIGS. 8 and 9.

FIGS. 8 and 9 illustrate the tabs 94 being disposed on the cover 23, with the fingers 92 being disposed on the housing 22. The tabs 94 may be disposed at various outer locations of the cover 23 (or housing 22), with corresponding fingers 92 being disposed on the opposite component (housing 22 or cover 23). The tabs 94 may extend downward and may define an upper surface 94a and an inclined surface 94b defining a downward taper. The tabs 94 may further include an inner surface 94c that defines a depression 94d. The depression 94d may be sized to receive a rounded outer surface 114c defined by the outer wall 114b that defines the passageway 115.

The fingers 92 may extend upwardly and include a bottom portion 92a and an upper portion 92b, with the upper portion 92b defining a notch 92c that is sized and configured to receive the tab 94 laterally therein. The fingers 92 may be bendable or flexible at the bottom portion 92a, such that the fingers 92 can flex outward in response to an outwardly directed force. The tabs 94 provide this outwardly directed force during assembly.

When assembled, the inclined portion 94b of the tab 94 will contact the upper portion 92b of the finger 92, and will push the upper portion 92a outward. When the tab 94 clears the upper portion 92b, the upper portion 92b may snap back such that the tab 94 is received in the notch 92c. The notch 92c will hold the tab 94 in place and against vertical movement. To remove the cover 23 and tab 94 in an upward direction, the finger 92 can be bent outwardly such that the tab 94 no longer extends into the notch 92c, and the tab 94 may be removed in an upward direction.

Additionally, when the housing 22 and cover 23 are assembled, the inner surface 94c of the tab 94 will pass over the outer surface 114c of the outer wall 114b of the housing 22. The rounded outer surface 114c will be received in the depression 94d defined in the inner surface 94c of the tab 94. During assembly, the tab 94 will flex slightly outward as it passes over the rounded outer surface 114c of the housing 22. Accordingly, an additional snap fit connection is achieved at this interface. This snap fit connection may be achieved around substantially the entire perimeter of the housing 22 and the cover 23 or at distinct locations. The interface between the tabs 94 and the finger 92 may be limited to distinct locations at the perimeter of the housing 22 and the cover 23.

The amount of compressive force required to make each of these snap fit connections is low, and the connection may be broken by freeing the tabs 94 from the fingers 92 and removing the cover 23 from the housing 22. However, due to the lack of compressive force applied to the seal member 96, there is little decompressive force that acts against the cover 23. Thus, the connection of the housing 22 to the cover 23 may be made without requiring the fasteners 90 to provide a substantial compressive force. Because the de-compressive force is low, the compressive force necessary to join the housing 22 and the cover 23 is reduced.

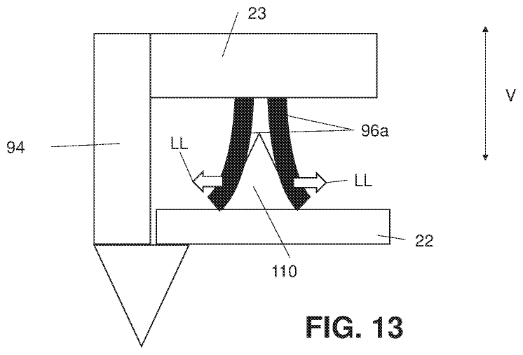

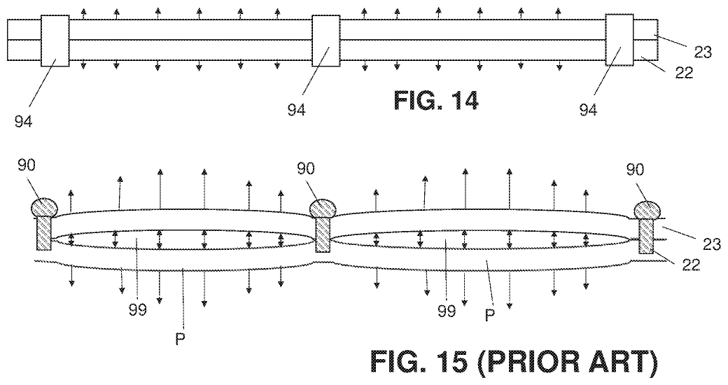

It will be appreciated that alternative snap fit connections may be used to hold the housing 22 and the cover 23 together, for example as illustrated in FIG. 13 and FIG. 14. As a result of a Lateral Load (LL) of the seal member 96, the housing 22 and the cover 23 experience no, or nearly no resistive vertical V forces acting to resist the housing 22 and the cover 23 from engaging in a sealed manner with one another. As a result, a manual snap-fit connection can be made without requiring large vertical forces necessitating tools to bring the housing 22 and cover 23 together into engagement. The above described components and features may be applied to either the housing 22 or the cover 23, with the corresponding feature disposed on the opposite component. For example, as mentioned above, the tabs 94 may be on the housing and the fingers 92 may be on the cover 23. The tab 94 may include a rounded or bulbous surface, and the corresponding depression may be formed in the cover 23 (or housing) where the bulbous surface of the tab 94 is received in a corresponding depression.

FIG. 9 illustrates that the seal member 96 and the tab 94 are associated with the same component (the cover 23), but they do not have to be part of the same component. The seal member 96 may be part of the cover 23 and the tab 94 may be part of the housing 22, or vice versa. Similarly, the deflector 110 and fingers 92 may be disposed one either the housing 22 or cover 23, and do not have to be on the same component.

The above described sealing arrangement between the housing 22 and the cover 23 may be applied to other portions of the latch assembly 20 where one component is joined together with another along a perimeter. As shown in FIGS. 4 and 5, the housing 22 and cover 23 are assembled and joined with the water shield 19 portion of the latch assembly 20. The water shield 19 could include a similar seal member and deflector (not shown) to create its enclosure. It will be appreciated that the sealing arrangement described above could be used on a latch assembly without the water shield 19. Similarly, the sealing arrangement may be used on other types of clamshell-type assemblies with a first portion and a second portion that are joined together to define a cavity, and the seal created without substantial compressive forces and maintained without decompressive reactions forces may enable a similar snap fit style connection to be used, potentially without the need for screw-type fasteners. The water shield 19 may be joined to the housing 22 and the cover 23 using other sealing methods as well.

While the above description has reference the use of snap fit connections and the potential for eliminating screw-type fasteners, it will be appreciated that the screw type fasteners may still be used. Advantageously, the screw type fasteners 90 may still be used to join the housing 22 and cover 23, but the torque applied to the fasteners 90 may be reduced when using the novel sealing arrangement described above, and the reduced torque may allow for a reduction in damage of buckling caused during assembly. FIG. 14 illustrates the even load distribution (arrows) acting on the cover 23 and the housing 22 between snap-fit connectors 94 as a result of the seal member 96 not being in a compressed state when the cover 23 and the housing 22 are engaged or assembled together. In comparison, FIG. 15 illustrates an uneven load distribution acting on a known cover 23 and housing 22 arrangement between screws 90 as a result of a seal member e.g. a solid seal block 99 or strip being in a compressed state when the cover 23 and the housing 22 are engaged or assembled together, resulting in a buckling, and displacement of the cover 23 from the housing 22 away from one another, which may result in an incomplete seal about the peaks P or other separate points illustrated in FIG. 15, allowing water etc. to ingress into the interior of the latch. Screws 90 are capable of overcoming the seal loading about their connection points, but at points displaced from the screws 90, the strength of the cover 23 and housing 22 is insufficient to resist the expansive tendency of the compressed seal 99.

Water is further inhibited from entering the internal cavity 27 beneath cover 23 at least in part due to the incorporation of the water shield 19. The water shield 19 may be attached to the cover 23 as described in U.S. patent application Ser. No. 16/034,420, filed Jul. 13, 2018 and titled “VEHICULAR LATCH ASSEMBLY WITH OPTIMIZED SEALING,” which is hereby incorporated by reference in its entirety. The water shield 19 and cover 23 are shown attached to one another via a fastening mechanism, and are shown, by way of example and without limitation, as being securely attached to one another via at least one or a plurality of threaded fasteners 90A and a slide mechanism 114. The slide mechanism 114 is shown as including a raised cam surface on the water shield 19 and a ledge or detent 118 on the cover 23, wherein the cam surface and detent 118 are configured to interact and engage one another.

The water shield 19 further inhibits water from entering the internal cavity 27 of latch assembly 20 in a coupling region of the release cables 21. As shown in FIGS. 4 and 5, seal members 126 are provided to form a water-tight seal to prevent, with the seal members 126 being configured as annular members, such as grommets or the like, to establish a fluid-tight seal about the release cables 21. Accordingly, with the housing 22 and cover 23 being brought into fluid-tight sealed relation with one another via the seal member 96; the water shield 19 and the cover 23 being brought into fluid-tight sealed relation with one another, and the release cables 21 being brought into fluid-tight sealed relation with the water shield 19 via the seal members 126, the latch assembly 20 is assured of being waterproof, thereby preventing the ingress of water into the internal cavity 27 thereof.

Further yet, as shown in FIG. 5, one or more seal members 136, 138 can be provided to form a water-tight seal between the latch assembly 20 and the body in white surface (BIW), such as an inner surface of the door edge face 15, to which the latch assembly 20 is fixedly attached. The seal member 136 is shown as extending about at least a portion of the latch assembly surface that is brought into abutment with the BIW, and the seal member 138 is shown being annular and as extending about the periphery of an opening through which the striker 28 passes. As such, water is further prevented from ingress between the latch assembly 20 and the BIW, thereby further enhancing the protection against potential damage caused by water, such as from water freezing and/or corrosion.

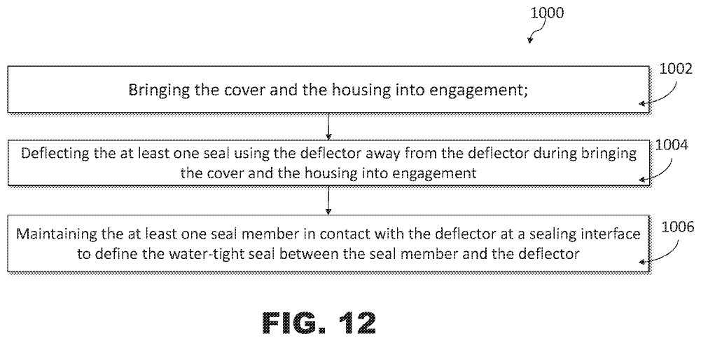

Now referring to FIG. 12, there is illustrated a flowchart of a method of assembling a latch assembly for a vehicle closure panel 1000, the latch assembly having a housing having an internal cavity configured for receipt of internal latch components, a cover configured to attach to the housing to enclose at least a portion of the internal cavity, at least one seal member configured to form a water-tight seal between the housing and the cover, and at least one deflector configured to contact the at least one seal member at a sealing interface to define the water-tight seal between the at least seal member and the deflector. The method 1000 includes the steps of bringing the cover and the housing into engagement 1002, deflecting the at least one seal using the deflector away from the deflector during bringing the cover and the housing into engagement 1004, and maintaining the at least one seal member in contact with the deflector at a sealing interface to define the water-tight seal between the seal member and the deflector 1006. The deflecting the at least one seal 1002 includes laterally moving the at least one seal away from the deflector, for example in a direction perpendicular to the direction of alignment when bringing the cover and the housing together into engagement. The deflecting the at least one seal 1002 does not compress the at least one seal. The method 1000 further includes the step of snap-fitting the cover and the housing into engagement.

While the teachings of the present disclosure are illustrated for sealing a latch assembly 20 at an interface between a housing 22 and a cover 23 of the latch assembly 20 to inhibit the ingress of water into an internal cavity 27 containing internal latch components between openings in the housing 22 and/or cover 23, the teachings may be applied to other types of housings, such as for example and without limitation: a latch assembly 20 having and electrical housing configured for sealing against a mechanical housing as illustrated in U.S. Ser. No. 10/370,875 entitled “Electrical vehicle latch having a fluid tight electrical housing”, the entire disclosure of which is incorporated herein by reference; other latch configurations whereby the housing includes mating housings; a housing for control electronics, for example a stand-alone latch control module, or latch housing 30 of and as illustrated in U.S. Ser. No. 10/047,548 entitled “Latch assembly for latch operation of closure panels for vehicles”, the entire disclosure of which is incorporated herein by reference; a sensor module having a housing for containing a sensor printed circuit board such as for radar sensing, as illustrated in U.S. Ser. No. 10/443,292 entitled “Non-contact obstacle detection system for motor vehicles”, the entire disclosure of which is incorporated herein by reference. Employing the teachings herein for sealing a sensor housing may allow for a connection of a housing and cover of the sensor module to employ a snap fit connection alternatively to metal fasteners such as metallic screw-type fasteners. Such metal type fasteners may interfere with sensing signals, such as with the transmitted and reflected radar signals emitted and received from radar antennas provided on the sensor printed circuit which may create “ghost” reflections and improperly transmitted signals leading to false activations and/or detections and configuration a sensor housing for sealing connection using the teachings herein without metal fasteners may improve sensing. While the above description constitutes a plurality of embodiments of the present invention, it will be appreciated that the present invention is subject to further modification and change without departing from the fair interpretation and intended meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a vehicle closure panel, comprising:
a housing having an internal cavity configured for receipt of internal latch components;
a cover attached to said housing to enclose at least a portion of said internal cavity;
at least one seal member configured to form a water-tight seal between said housing and said cover;
at least one deflector in contact with the at least one seal member at a sealing interface to define the water-tight seal between the at least one seal member and the deflector, wherein the deflector includes a top portion and a side portion;
wherein the at least one seal member is disposed on one of either the housing or the cover, and the deflector is disposed on the other of the housing or the cover;
wherein the at least one seal member is deflected by the side portion of the deflector relative to a nominal position of the seal member, wherein the sealing interface is disposed on the side portion of the deflector.

2. The latch assembly of claim 1, wherein the at least one seal member is a single flexible lip member laterally offset from a center of the deflector.

3. The latch assembly of claim 1, wherein the at least one seal member includes a pair of flexible lip members, each of which are laterally offset from a center of the deflector and contact opposite sides of the deflector.

4. The latch assembly of claim 1, wherein the nominal position of the seal member interferes with the deflector.

5. The latch assembly of claim 1, wherein the housing and the cover combine to define a passageway in which the at least one seal member and the deflector are disposed.

6. The latch assembly of claim 5, wherein the passageway has a height, and the at least one seal member has a height that is less than the height of the passageway.

7. The latch assembly of claim 5, wherein the passageway has a height and the at least one seal member has a nominal height that is greater than the height of the passageway, wherein the at least one seal member is bent relative to its nominal position within the passageway and contacts a surface of the passageway.

8. The latch assembly of claim 1, wherein the housing and the cover are secured to each other by a snap fit connection.

9. The latch assembly of claim 8, wherein the housing and the cover are secured to each other without the use of screw-type fasteners.

10. The latch assembly of claim 1, wherein the deflector has a tapered cross-section.

11. A latch assembly for a vehicle closure panel, comprising:
a housing having an internal cavity configured for receipt of internal latch components;
a cover configured to attach to the housing to enclose at least a portion of the internal cavity;
at least one seal member configured to form a water-tight seal between said housing and said cover;
at least one deflector configured to contact the at least one seal member at a sealing interface to define the water-tight seal between the at least one seal member and the deflector;
wherein the assembly has a disassembled state and an assembled state;
wherein, in the disassembled state, the at least one seal member has a nominal state and is disposed above the deflector and aligned with a side of the deflector;
wherein, in the assembled state, the at least one seal member is in contact with the side of the deflector and deflected relative to the nominal state and defines the sealing interface.

12. The latch assembly of claim 11, wherein the housing is secured to the cover in the assembled state via a snap fit connection.

13. The latch assembly of claim 11, wherein the sealing member is not compressed between the housing and the cover.

14. The latch assembly of claim 12, wherein the housing is secured to the cover without screw-type fasteners.

15. The latch assembly of claim 11, wherein the deflector includes an uppermost tip that does not contact the sealing member in the assembled condition.

16. The latch assembly of claim 11, wherein the sealing member includes a single flexible lip that is offset from a center of the deflector in both the disassembled and the assembled conditions.

17. The latch assembly of claim 11, wherein the sealing member includes a pair of flexible lips, each of which are offset from a center of the deflector in both the disassembled and the assembled conditions.

18. A method of assembling a latch assembly for a vehicle closure panel, the latch assembly comprising a housing having an internal cavity configured for receipt of internal latch components, a cover configured to attach to the housing to enclose at least a portion of the internal cavity, at least one seal member configured to form a water-tight seal between said housing and said cover, and at least one deflector configured to contact the at least one seal member at a sealing interface to define the water-tight seal between the at least seal member and the deflector, the method comprising the steps of:
bringing the cover and the housing into engagement;
deflecting the at least one seal member using the deflector away from the deflector during the step of bringing the cover and the housing into engagement; and
maintaining the at least one seal member in contact with the deflector at a sealing interface to define the water-tight seal between the seal member and the deflector.

19. The method of claim 18, wherein the deflecting the at least one seal member does not compress the at least one seal member.

20. The method of claim 18, further including the step of snap-fitting the cover and the housing into engagement.
